(19) United States
(12) Patent Application Publication
(10) Pub. No.: US 2026/0128185 A1
(43) Pub. Date: May 7, 2026

(54) MICRO INTEGRAL NUCLEAR REACTOR

(71) Applicant: Hadron Energy, Inc., Redwood City, CA (US)

(72) Inventors: Samuel Gibson, New York, NY (US); Christopher R. Neal, San Francisco, CA (US); Ross Ridenoure, Omaha, NE (US); Andrew M. Ward, Ann Arbor, MI (US)

(21) Appl. No.: 19/376,455

(22) Filed: Oct. 31, 2025

Related U.S. Application Data
(60) Provisional application No. 63/715,445, filed on Nov. 1, 2024.

(51) Int. Cl. G21C 1/32; G21C 3/60; G21C 11/06; G21C 15/243

(52) U.S. Cl. CPC G21C 1/32; G21C 3/60; G21C 15/243; G21C 11/06

(57) ABSTRACT

A micro integral nuclear reactor and nuclear power system including the micro integral nuclear reactor. The micro integral nuclear reactor can include a reactor core, a steam generator, primary coolant circuit, and a reactor pressure vessel. The reactor pressure vessel can houses the reactor core, the steam generator, and the primary coolant circuit. The fuel of the reactor core can be enriched to a concentration of 5 percent or greater and less than 20 percent U-235 by weight of uranium within the reactor core. When operating, the micro integral nuclear reactor can produce a thermal power output from 6 megawatts-thermal (MWt) to 60 MWt. The nuclear power system can in lude a turbine-generator assembly fluidly coupled to the steam generator and, when operating, the nuclear power system produces an electrical power output from 2 megawatts-electric (MWe) to 20 MWe.

### CROSS-REFERENCE TO RELATED APPLICATIONS

This application claims the benefit under 35 U.S.C. § 119(e) of U.S. Provisional Patent Application No. 63/715,445 , filed Nov. 1, 2024, and titled “MICRO MODULAR REACTORS AND USES THEREOF,” the entirety of which is incorporated herein by reference.

### TECHNICAL FIELD

The present disclosure relates to nuclear reactors for power generation, particularly nuclear reactors for electrical power generation.

### BACKGROUND

Nuclear reactors for power generation rely on controlled fission reactions within a reactor core to produce thermal energy. The thermal energy is typically transferred to a working fluid through a primary coolant loop. The working fluid can be used to generate steam that drives a turbine coupled to an electrical generator.

### SUMMARY

The subject matter described herein generally relates to compact, integral, nuclear reactors and to nuclear power systems that use such integral reactors. The nuclear power systems and nuclear reactors can be configured to generate thermal energy and electrical power through controlled nuclear fission. The nuclear reactor can be a pressurized-water reactor.

In one aspect, the subject matter described herein relates to a micro integral nuclear reactor including a reactor core, a steam generator, primary coolant circuit, and a reactor pressure vessel. The reactor core includes a plurality of fuel assemblies. Each fuel assembly comprises a plurality of fuel elements. The plurality of fuel assemblies define core primary coolant flow passages through the reactor core. The reactor core is structured such that, when operating, a primary coolant flows through the core primary coolant flow passages and absorbs heat generated by nuclear fission within the reactor core. Each fuel element containing uranium-235 (U-235), and the fuel of the reactor core is enriched to a concentration of 5 percent or greater and less than 20 percent U-235 by weight of uranium within the reactor core. The steam generator is fluidly connected to the core primary coolant flow passages to receive the primary coolant and, when operating, transfer heat from the primary coolant to a secondary coolant to generate steam. The primary coolant circuit fluidly couples the core primary coolant flow passages and the steam generator such that, when operating, the primary coolant circulates between the reactor core and the steam generator. The reactor pressure vessel houses the reactor core, the steam generator, and the primary coolant circuit. When operating, the micro integral nuclear reactor produces a thermal power output from 6 megawatts-thermal (MWt) to 60 MWt.

In another aspect, the subject matter described herein relates to a nuclear power system including a micro integral nuclear reactor, a turbine-generator assembly, a condenser, and a secondary-coolant circuit. The micro integral nuclear reactor includes a reactor core, a steam generator, primary coolant circuit, and a reactor pressure vessel. The reactor core includes a plurality of fuel assemblies. Each fuel assembly comprises a plurality of fuel elements. The plurality of fuel assemblies define core primary coolant flow passages through the reactor core. The reactor core is structured such that, when operating, a primary coolant flows through the core primary coolant flow passages and absorbs heat generated by nuclear fission within the reactor core. Each fuel element containing uranium-235 (U-235), and the fuel of the reactor core is enriched to a concentration of 5 percent or greater and less than 20 percent U-235 by weight of uranium within the reactor core. The steam generator is fluidly connected to the core primary coolant flow passages to receive the primary coolant and, when operating, transfer heat from the primary coolant to a secondary coolant to generate steam. The primary coolant circuit fluidly couples the core primary coolant flow passages and the steam generator such that, when operating, the primary coolant circulates between the reactor core and the steam generator. The reactor pressure vessel houses the reactor core, the steam generator, and the primary coolant circuit. The turbine-generator assembly is fluidly coupled to the steam generator to receive the steam and, when operating, generate electrical power and discharge exhaust. The condenser is fluidly coupled to the turbine-generator assembly to condense the exhaust into condensed secondary coolant. The secondary-coolant circuit is fluidly coupling the steam generator, the turbine-generator assembly, and the condenser such that, when operating, the condensed secondary coolant is returned from the condenser to the steam generator to complete a recirculating flow path. When operating, the nuclear power system produces an electrical power output from 2 megawatts-electric (MWe) to 20 MWe.

In a further aspect, the subject matter described herein relates to a micro integral nuclear reactor including a reactor core, one or more neutron reflectors surrounding the reactor core, a steam generator, primary coolant loop, a pressurizer, and a reactor pressure vessel. The reactor core includes a plurality of fuel assemblies. Each fuel assembly comprises a plurality of fuel elements. The plurality of fuel assemblies define core primary coolant flow passages through the reactor core. The reactor core is structured such that, when operating, a primary coolant flows through the core primary coolant flow passages and absorbs heat generated by nuclear fission within the reactor core. Each fuel element containing uranium-235 (U-235), and the fuel of the reactor core is enriched to a concentration of 5 percent or greater and less than 20 percent U-235 by weight of uranium within the reactor core. The steam generator is fluidly connected to the core primary coolant flow passages to receive the primary coolant and, when operating, transfer heat from the primary coolant to a secondary coolant to generate steam. The one or more neutron reflectors are circumferentially disposed around the reactor core. The steam generator is fluidly connected to the core primary coolant flow passages to receive the primary coolant and, when operating, transfer heat from the primary coolant to a secondary coolant to generate steam. The primary coolant loop fluidly couples the core primary coolant flow passages and the steam generator such that, when operating, the primary coolant circulates between the reactor core and the steam generator. The primary coolant is light water. The pressurizer is fluidly connected to the primary coolant loop and configured to regulate the pressure of the primary coolant at an operating pressure sufficient to maintain the primary coolant in a liquid state during operation. The reactor pressure vessel houses the reactor core, the steam generator, the primary coolant loop, and the pressurizer. When operating, the micro integral nuclear reactor produces a thermal power output from 6 megawatts-thermal (MWt) to 60 MWt.

These and other aspects of the subject matter described herein will become apparent from the following disclosure. This summary presents illustrative aspects of the subject matter described herein and is not intended to limit the scope of the invention, which is defined by any claims supportable by this disclosure and the equivalents of the embodiments and structures discussed herein.

### BRIEF DESCRIPTION OF THE DRAWINGS

FIG. 1 is a schematic of a nuclear power system.

FIGS. 2A and 2B are perspective views showing one end of a micro modular reactor (MMR) that can be used in the nuclear power system of FIG. 1. FIG. 2B shows a reactor pressure vessel of the MMR as transparent so the internal components can be seen.

FIGS. 3A and 3B are perspective views showing the other end of the MMR shown in FIGS. 2A and 2B. FIG. 3B shows a reactor pressure vessel of the MMR as transparent so the internal components can be seen.

FIGS. 4A, 4B, and 4C are side views of the of the MMR shown in FIGS. 2A and 2B. FIG. 4B shows a reactor pressure vessel of the MMR as transparent so the internal components can be seen. FIG. 4C is an exploded view.

FIGS. 5A, 5B, and 5C show an MMR that can be used in the nuclear power system of FIG. 1. FIG. 5A is a perspective partial cutaway view of the MMR, FIG. 5B is a front partial cutaway view of the MMR, and FIG. 5C is a side partial cutaway view of the MMR.

FIG. 6 is a schematic depicting multi-unit configuration of a nuclear power system.

### DETAILED DESCRIPTION OF THE PREFERRED EMBODIMENTS

Reliable, clean, and adaptable sources of energy are increasingly important for supporting electrical grids, industrial operations, and remote communities. Developments in nuclear power generation have focused on systems that can provide consistent and scalable energy output with reduced environmental impact. As described above, conventional nuclear power plants rely on large, stationary reactor installations that produce thermal energy through controlled nuclear fission reactions. The thermal energy is transferred to a working fluid within a primary coolant loop and converted into electrical energy through turbine-driven generators. These systems provide substantial and continuous power output but typically require large containment structures, extensive support infrastructure, and complex auxiliary systems. Such requirements can restrict deployment to centralized sites with sufficient grid capacity and construction capability.

In contrast, a modular reactor enables greater flexibility in nuclear power deployment. A modular reactor can be manufactured as a standardized unit under controlled factory conditions and transported to an installation site for assembly. The modular approach can provide benefits such as consistent quality assurance, reduced on-site construction time, and scalable power output through the addition of multiple modules. This approach also enables staged deployment strategies that can adapt to evolving power demands and site constraints. Factory-assembled modules can be transported by standard over-the-road or marine equipment and interconnected on site to form one or more nuclear power systems supplying a common electrical or thermal load.

Micro modular reactors (MMRs) disclosed herein can be compact, transportable nuclear power systems capable of generating several megawatts of electrical power along with corresponding thermal output. Each unit can be assembled, sealed, and tested prior to shipment. Once deployed, the reactor can operate as a stand-alone power source or as part of an array of coordinated modules. Thermal energy produced by the reactor can be used for electricity generation or for supplying process heat to industrial or district energy systems. Certain embodiments can be designed for extended operation without refueling. The small physical scale of such systems enables installation in remote, industrial, or off-grid environments that are unsuitable for conventional nuclear facilities.

The design of micro modular reactors is not achieved by directly scaling down conventional large-scale reactor systems. The substantial reduction in reactor size and the requirement for modularity introduce significant engineering challenges including challenges in core physics, heat transfer, coolant dynamics, structural integrity, and long-term materials performance. Parameters such as neutron moderation, coolant flow distribution, and thermal margins behave differently at smaller scales, requiring new design strategies to maintain stable operation and safety performance equivalent to or better than that of larger reactors.

The reactor systems described herein address these challenges through compact pressurized-water reactor (PWR) designs that utilize light water as both coolant and moderator. In some aspects, the disclosed micro modular reactors generate 20 megawatts of electrical power (megawatts-electric or MWe) or less, such as from 2 MWe to 20 MWe, from 5 MWe to 15 MWe, or from 5 MWe to 10 MWe. In some embodiments, the micro integral nuclear reactor can produce a thermal power output from 6 megawatts-thermal (MWt) to 60 MWt corresponding to an electrical power output of approximately 2 megawatts-electric (MWe) to 20 MWe. For example, the micro integral nuclear reactor can produce a thermal power output from 15 MWt to 45 MWt or from 15 MWt to 30 MWt. The MMRs discussed herein can be integral reactor designs. In such an integral reactor design, the reactor core, steam generator, and primary-coolant circuit components can be integrated within an integral pressure vessel. This arrangement provides a self-contained primary system that facilitates transport, installation, and modular assembly while reducing the number of external connections. Such compact integral configurations can exhibit reduced system mass, simplified transport and installation logistics, and operational characteristics suitable for long-duration, modular deployment. Unlike traditional large-scale pressurized-water reactors that rely on extensive external piping, pumps, and stand-alone steam generators, the MMR integrates all primary components within a single pressure vessel. This integral configuration results in a simplified and compact system architecture that supports safe operation, efficient heat transfer, and reduced installation complexity within a small physical footprint.

The MMRs discussed herein can be an integral pressurized-water reactor comprising the reactor core, the primary coolant, and primary-side components, including an internal steam generator and, in some embodiments, an internal pressurizer, all housed within a single reactor pressure vessel. The MMR can be part of a nuclear power system that includes the MMR together with one or more balance-of-plant subsystems, including a secondary-coolant circuit, a turbine-generator assembly, a condenser, heat-rejection equipment, and instrumentation, control, and protection subsystems. Multiple nuclear power systems can be deployed and operated together in a modular multi-unit configuration to increase aggregate electrical output or to provide redundancy.

In the MMRs described herein, electrical and thermal energy generation is based on the controlled process of nuclear fission occurring within a reactor core. The reactor core comprises fissile material, structural elements, and primary-coolant flow passages arranged to support a sustained and controllable fission reaction. In general, the reactor core is configured to convert nuclear binding energy released by fission events into thermal energy that is transferred to a circulating primary coolant.

The fission process involves the splitting of heavy atomic nuclei, such as uranium-235 (U-235), into smaller nuclei known as fission products. When a U-235 nucleus absorbs a neutron, it becomes unstable and divides into two or more fission fragments. Each fission event releases energy in the form of kinetic energy of the fission fragments and gamma radiation. The released energy is transferred to the surrounding fuel material as heat, which is extracted by the primary coolant circulating through the reactor core.

The fuel used in the systems described herein can comprise uranium-235 (U-235). In the MMRs disclosed herein, the reactor core is significantly smaller than the core of a conventional large-scale nuclear reactor. Because of this reduced core volume, the fuel is enriched to a higher concentration of U-235 than that used in traditional reactor systems to sustain a stable and continuous fission reaction. The fuel can comprise enriched uranium in which the concentration of U-235 is increased above that of naturally occurring uranium, which typically contains about 0.7 percent U-235 by weight. In some embodiments, the uranium is enriched to a concentration of 5 percent or greater and less than 20 percent U-235 by weight. In certain embodiments, the enrichment level can range from 5 percent to 10 percent U-235 by weight. In some embodiments, the uranium enrichment can be selected to balance reactivity, fuel utilization, and refueling interval for the compact reactor geometry.

The uranium can be enriched from 6 percent and 9.9 percent U-235 by weight, and in certain embodiments from 6 percent and 8.5 percent U-235 by weight. These enrichment levels can provide an optimal combination of burnup performance and long-term reactivity control for micro integral reactors designed for extended operation, such as a refueling interval of approximately ten years. The enrichment range can be determined based on the reactor-core size, total fissile inventory, and projected fuel burnup to maintain a substantially uniform power output over the operational cycle. In certain embodiments, the fuel can comprise high-assay low-enriched uranium (HALEU) enriched to up to 20 percent U-235 by weight.

The uranium fuel can be provided in one or more fuel elements arranged within the reactor core, such as a plurality of fuel elements. Each fuel element can contain fissile material enclosed within a cladding structure. The cladding structure defines a containment boundary for the fuel and provides a heat-transfer surface between the fuel and the primary coolant. In some embodiments, the fuel element can be a fuel rod, and the cladding structure can form the wall of a tubular enclosure surrounding the fuel material. The fissile material can comprise uranium oxide, such as uranium dioxide (UO₂) pellets. The cladding can comprise a zirconium-based alloy, such as zircaloy, ZIRLO®, or M5®. In other embodiments, the cladding can comprise stainless steel, a nickel-based alloy, a FeCrAl alloy, or a silicon-carbide-based composite. The fuel elements can be formed in various configurations depending on reactor design and power requirements. In some embodiments, the fuel elements can comprise cylindrical rods or tubular pins. In other embodiments, the fuel elements can comprise flat plates, compacts, or pebbles. The fuel elements can be organized into one or more fuel assemblies, such as a plurality of fuel assemblies. The fuel assemblies, either individually or collectively, can define primary-coolant flow passages that allow the circulating primary coolant to remove heat from the reactor core efficiently. These enrichment levels and structural configurations provide a sufficient fissile isotope concentration and thermal design arrangement to sustain controlled fission reactions within the compact reactor core of the MMR.

Each fission event produces multiple neutrons that can initiate additional fission reactions within the reactor core. The neutrons released from fission have relatively high kinetic energies and must be slowed to thermal energy levels to efficiently sustain further fission in uranium-235 fuel. In the MMRs described herein, light water (H2O) functions as the primary coolant and as a neutron moderator. The reactor core can be arranged such that the primary coolant circulates in thermal communication with the fuel assemblies while simultaneously moderating the neutron population. As fast neutrons collide with hydrogen atoms in the primary coolant, they lose kinetic energy and are reduced to thermal velocities. Thermal neutrons are more readily absorbed by U-235 nuclei, thereby sustaining a controlled and continuous chain reaction. The use of light water as both the primary coolant and the neutron moderator provides an effective and well-characterized mechanism for reactivity control and heat removal within the compact reactor core.

As fission reactions occur within the fuel, the resulting kinetic energy of the fission fragments and associated gamma radiation are converted to heat within the reactor core. The reactor core can include fuel arranged in various geometric configurations, such as assemblies, rods, or plates, supported within structural elements that define primary-coolant flow passages. The primary-coolant flow path extends through or around the fuel regions to remove the generated heat efficiently. The circulating primary coolant transfers thermal energy away from the fuel during operation. In some embodiments, the reactor operates as a pressurized-water reactor in which the primary coolant is maintained under pressure to prevent boiling within the reactor core. The heated, pressurized primary coolant exits the reactor core and circulates through a primary-coolant circuit, such as a primary-coolant loop, where it transfers thermal energy to a secondary system. The secondary system can use the transferred energy to generate electricity or provide process heat. The configuration of the primary-coolant flow path and the geometry of the reactor core can be designed to provide uniform heat removal and stable thermal-hydraulic performance throughout the fuel region.

As fission reactions proceed within the reactor core, the heat generated by the fuel is absorbed by the circulating primary coolant. The temperature and neutron population within the reactor core are regulated to maintain a stable rate of fission and to prevent excessive reactivity. The systems described herein can include one or more reactivity control mechanisms configured to absorb neutrons and regulate the fission chain reaction.

In some embodiments, reactivity control within the reactor core is achieved through mechanically inserted neutron absorbers. The reactor core can include a plurality of vertically oriented control rods arranged in redundant banks to provide both coarse and fine reactivity adjustment during normal operation and rapid shutdown (SCRAM) capability when required. Routine rod positioning can be accomplished by motor-driven control-rod drive mechanisms that provide precise control for power shaping and load-following operation. Each shutdown bank can be capable of full insertion by gravity, providing a passive scram function for rapid reactivity suppression. Each control rod can comprise a material having a high neutron-absorption cross section, such as boron carbide (B₄C), hafnium, or a silver-indium-cadmium alloy. The control rods can be positionable at a plurality of different locations within the reactor core to achieve precise reactivity control. The control rods can be insertable into or withdrawable from the reactor core to decrease or increase neutron flux, respectively, thereby controlling reactivity during startup, steady-state operation, and shutdown.

A reactor protection and control system can continuously monitor neutron flux, coolant temperature, pressure, and other core parameters, and can automatically actuate rod motion or initiate a full scram upon detection of predefined off-normal conditions to ensure prompt subcriticality. The combination of mechanical drive systems, gravity-driven scram capability, and automated digital control provides redundant and reliable reactivity management within the compact architecture of the micro modular reactor.

In some embodiments, the reactor core can include burnable poisons incorporated into the fuel or placed in dedicated absorber elements to provide long-term reactivity control. The burnable poisons can comprise materials having a high neutron-absorption cross section that gradually decreases as the material is transmuted during reactor operation. Suitable burnable poison materials can include boron-based materials or gadolinium-based materials, such as zirconium diboride (ZrB₂) or gadolinium oxide (Gd₂O). The burnable poisons can be integrated coatings applied to the fuel cladding or fuel, such as the fuel pellets. The use of burnable poisons can offset the initial excess reactivity of freshly loaded fuel, improve neutron flux uniformity across the core, and extend core life by maintaining a more consistent reactivity profile over the operating cycle. In combination with the control-rod system and enriched fuel composition, the inclusion of burnable poisons can contribute to longer refueling intervals and stable power output within the compact configuration of the MMR.

In certain embodiments, the primary coolant can contain a neutron-absorbing material dispersed within the primary coolant to provide an additional means of reactivity control. The neutron-absorbing material can comprise a soluble neutron-absorbing substance, such as a boron-based compound. For example, the soluble neutron-absorbing material can comprise boric acid (H₃BO₃), which dissociates within the primary coolant to release boron ions that absorb neutrons during reactor operation. The concentration of the soluble neutron-absorbing material within the primary coolant can be adjusted to fine-tune core reactivity over the course of the fuel cycle. The combination of solid control rods and coolant-borne neutron-absorbing material provides redundant and adjustable means for maintaining the reactor in a controlled, self-sustaining condition under a range of operating and transient states. The use of both mechanical and coolant-based reactivity control systems enables stable operation of the reactor core across variable power levels and thermal conditions.

During normal operation of the systems described herein, the relationship among fuel composition, moderator performance, and control-rod positioning maintains the reactor at a steady operating condition referred to as criticality, in which each fission event causes, on average, one subsequent fission event. Under these conditions, the rate of heat generation within the reactor core remains substantially constant. The thermal energy produced by the fission process is transferred from the reactor core to the primary coolant within the primary-coolant circuit, such as the primary coolant circulating within the primary-coolant loop. The heated primary coolant conveys the energy to a secondary system, where it can be used to generate steam. The steam drives a turbine coupled to an electrical generator, converting the thermal energy from the reactor into electrical power. In some embodiments, including when the MMR is a PWR, the primary coolant transfers heat to a secondary-coolant circuit through a heat exchanger, thereby producing steam without direct contact between the primary and secondary fluids.

The nuclear fission process produces a range of fission products and transmutation isotopes within the reactor core. Representative fission products can include isotopes such as xenon-135, cesium-137, and iodine-131. These isotopes contribute to the neutron economy and must be considered in reactivity management and fuel cycle design. In addition, neutron absorption by uranium-238 (U-238) can yield neutron-rich isotopes, including plutonium-239 (Pu-239), which can subsequently undergo fission and contribute to the overall energy output. The continuing absorption and fission of such transmuted isotopes provide a secondary source of thermal energy, supporting sustained reactor operation and fuel utilization efficiency within the MMR.

In some embodiments, one or more neutron reflectors can be positioned to circumscribe the reactor core to improve neutron economy and sustain the fission chain reaction efficiently. The neutron reflectors can be circumferentially spaced about the reactor core and disposed radially outward from the outer boundary of the fuel region. In certain embodiments, the neutron reflectors can also include axial neutron reflector sections positioned above and below the reactor core to limit neutron leakage in both the radial and axial directions.

Because the reactor core of a micro modular reactor has a relatively small diameter compared to conventional reactors, a greater fraction of neutrons can escape from the core without causing additional fission events. The inclusion of neutron reflectors mitigates this neutron leakage and enables efficient operation of a compact reactor core. The neutron reflectors can comprise materials such as light water, heavy water, or graphite configured to reflect escaping neutrons back into the reactor core. In some embodiments, a layer of light water located adjacent to the reactor core can function as a neutron reflector by returning neutrons toward the fuel region. The neutron reflectors can be arranged as discrete components surrounding the reactor core or integrated into the surrounding containment or vessel structure. In certain embodiments, a steel structural assembly can at least partially encircle the reactor core and the primary coolant, serving as both a neutron reflector and a containment barrier. The steel structure can provide mechanical strength and pressure resistance while also contributing to overall reactor stability and neutron economy.

In some embodiments, the MMR includes a reactor pressure vessel (RPV) that houses the reactor core, the primary coolant, and associated reactivity control components. The RPV can comprise a thick-walled steel structure configured to contain the nuclear fuel and control rods under high-temperature and high-pressure operating conditions. In this context, the thickness of the thick-walled steel structure is a thickness sufficient to maintain structural integrity and pressure containment under the reactor operating conditions. The wall thickness can be selected in relation to the vessel diameter and design pressure to ensure that the RPV remains within allowable stress limits for the material under operating and transient temperature conditions.

The RPV defines a sealed pressure boundary that ensures containment of the primary coolant and reactor internals during normal operation and transient conditions. In certain embodiments, the RPV can have a pill-shaped geometry comprising a cylindrical central section with hemispherical end caps. The cylindrical central section can provide the primary volume for the reactor core and the primary-coolant flow region. The hemispherical end caps can close each axial end of the vessel, distributing pressure loads uniformly and minimizing localized stress concentrations. This geometry can provide an optimized volume-to-surface-area ratio, maximizing internal volume while minimizing external surface area exposed to heat loss.

In some embodiments, the height of the reactor pressure vessel is greater than the diameter of the reactor pressure vessel. The reactor pressure vessel can have an external diameter sized from 1 meter to 5 meters depending on power rating and containment configuration. The reactor pressure vessel dimensions can be selected to accommodate transportation and handling constraints while maintaining structural integrity and thermal performance. In some embodiments, the reactor pressure vessel can be dimensioned to fit within standard transport envelopes, such as a shipping container having an internal width of approximately 2.3 meters or a United States Air Force (USAF) 463L pallet having a width of approximately 2.1 meters. The dimensional configuration can enable the assembled or modular reactor vessel to be transported using conventional over-the-road or airlift logistics systems for deployment in remote or temporary installations. When a separate containment structure is positioned around the RPV, the overall system dimensions can drive the selected reactor pressure vessel diameter toward the lower end of the specified range to allow clearance for the containment vessel and for the annular spacing between the reactor pressure vessel and the containment structure. The dimensional configuration can enable the assembled or modular reactor vessel to be transported using conventional over-the-road or airlift logistics systems for deployment in remote or temporary installations. The RPV can be 1 meter or greater, such as 1.5 meters or greater, and the RPV can be 5 meters or less, such as 3.5 meters or less, 3 meters, 2.3 meters or less, 2.1 meters or less, or 2 meters or less. For example, the diameter of the RPV can be from 1 meter to 5 meters, such as 1 meter to 3.5 meters, 1 meter to 3 meters, 1 meter to 2.3 meters, 1 meter to 2.1 meters, or 1 meter to 2 meters.

In this context, the term “diameter” refers to a characteristic transverse dimension of the RPV. In embodiments where the RPV is substantially cylindrical, the diameter corresponds to the external cross-sectional dimension of the RPV measured through its central longitudinal axis. In other embodiments where the RPV is non-cylindrical, the diameter can be defined as the diameter of the smallest circle that fully circumscribes the external cross-sectional profile of the RPV, excluding external attachments such as flanges, nozzles, or piping connections. The diameter may vary along the axial length of the RPV due to local geometric transitions, wall thickness changes, or the inclusion of domed, tapered, or dished end sections. Unless otherwise specified, references to the “diameter” of the RPV refer to a representative or nominal external diameter, which can correspond to an average, maximum, or predominant transverse dimension of the main body section of the RPV, depending on context.

In some embodiments, the cylindrical central section of the RPV can include one or more radial flanges or circumferential coupling bands. These flanges can divide the RPV into multiple vessel segments that are mechanically joined to form the overall vessel assembly. Each flange can provide a structural interface allowing selected vessel sections to be removed, replaced, or serviced without disassembling the entire reactor pressure vessel. The vessel flange design can facilitate factory-based construction, transportability, and on-site assembly of the reactor system. In certain embodiments, sealing members or high-strength bolted joints can be positioned between adjoining flanged sections to maintain the integrity of the pressure boundary.

The pill-shaped configuration can facilitate streamlined coolant flow around the reactor core by eliminating sharp transitions or edges, thereby reducing flow separation and turbulence within the vessel. The internal flow pattern can promote uniform heat removal from the reactor core and improve thermal-hydraulic stability. The continuous curvature of the end caps can also enhance structural strength and fatigue resistance under cyclic pressurization. The geometry of the RPV can therefore contribute to both mechanical integrity and cooling efficiency within the compact design of the micro modular reactor.

In some embodiments, the RPV can be constructed from reactor-grade steel or another high-strength alloy suitable for high-temperature and high-pressure environments. Such reactor-grade steel can be a low-alloy, high-strength steel such as ASTM A533, or a comparable material having mechanical properties sufficient to maintain strength, ductility, and fracture toughness under neutron irradiation.

In certain embodiments, portions of the RPV exposed to the primary coolant can include protective surface coatings or liner materials that enhance corrosion resistance and extend service life. The coatings can comprise corrosion-resistant compositions, including metal-based or metallic compositions, or other materials selected to resist oxidation, erosion, or chemical degradation. In some embodiments, suitable corrosion-resistant compositions can include nickel-based alloys or other metallic coatings applied to interior or wetted surfaces of the vessel. The protective layer can reduce metal oxidation, minimize material loss due to corrosion, and limit hydrogen ingress into the vessel wall.

In some embodiments, the MMR can include a pressurizer fluidly connected to the primary-coolant loop for regulating the pressure of the primary coolant during operation. The pressurizer can define a pressure-control volume that is partially filled with the primary coolant and partially occupied by a vapor region. The vapor region can accommodate expansion and contraction of the primary coolant resulting from temperature and pressure variations within the primary-coolant circuit. The pressurizer can include one or more heaters extending into the pressure-control volume to raise the temperature of the primary coolant within the pressurizer, thereby increasing system pressure. The pressurizer can further include one or more spray assemblies located in an upper portion of the pressure-control volume. The spray assemblies can introduce cooler primary coolant into the vapor region to condense a portion of the vapor and reduce pressure when required. In some embodiments, the pressurizer can be disposed within the RPV and can share the same pressure boundary as the primary-coolant loop. Integrating the pressurizer with the primary-coolant circuit and, in some embodiments, locating it within the RPV can simplify the overall system architecture, reduce external piping and pressure-boundary penetrations, and enhance operational reliability within the compact configuration of the micro modular reactor. In contrast to conventional systems that employ a separate external pressurizer vessel, the integrated pressurizer described herein forms part of the primary pressure boundary, maintaining liquid-phase coolant conditions within the confined geometry of the RPV.

In some embodiments, the MMR can include a primary-coolant loop that circulates the primary coolant between the reactor core and the steam generator housed within the RPV. The primary-coolant loop can define a continuous flow path extending through the core primary-coolant flow passages, around the reactor core, and through the heat-exchange region of the steam generator. The primary-coolant loop can be circumferentially disposed about the reactor core, such that at least a portion of the circulating primary coolant surrounds the outer periphery of the reactor core. In this arrangement, the circulating primary coolant can function as a neutron reflector, as discussed above, returning neutrons toward the fuel region and enhancing neutron economy within the compact core geometry.

In some embodiments, the primary-coolant loop can include a primary-coolant pump disposed within the RPV and coupled to the primary-coolant loop to circulate the primary coolant through the core primary-coolant flow passages and the steam generator during operation. The pump can be an electromagnetic, centrifugal, or canned-motor pump designed for submerged operation within the pressurized coolant environment. Locating the pump inside the RPV can reduce external piping, minimize potential leak paths, and simplify the overall reactor layout. In other embodiments, the primary-coolant loop can operate under natural-circulation conditions in which coolant motion is driven by density differences between heated coolant rising from the reactor core and cooled coolant descending from the steam generator. In this configuration, the primary-coolant loop can include vertical riser passages positioned above the reactor core and downcomer passages located around the core periphery. The natural-circulation arrangement can provide passive cooling during normal operation or shutdown conditions without requiring mechanical pumping.

The primary-coolant loop geometry, including pumping capability or natural-circulation pathways, enables efficient heat transport within the integral reactor system while maintaining the compact and self-contained design of the micro modular reactor. The primary-coolant piping can be compactly arranged within the RPV, thereby reducing the total coolant volume while maintaining flow rates sufficient for heat transfer through the reactor core and the steam generator. This compact piping arrangement can decrease system mass, shorten coolant flow paths, and enhance overall thermal-hydraulic performance within the integrated configuration of the MMR.

In some embodiments, the steam generator can be integrated within the RPV as part of an integral reactor configuration. Locating the steam generator inside the RPV can reduce the overall system size, eliminate external steam-generator vessels, and minimize piping between the primary- and secondary-coolant circuits. The steam generator can comprise a heat exchanger that includes one or more heat-transfer structures, such as tubes or plates. One of the primary coolant or the secondary coolant can flow through internal passages of the heat-transfer structures, while the other flows on the shell side of the steam generator or through surrounding flow channels. Heat conducted through the heat-transfer surfaces converts the secondary coolant into steam within the steam generator. The steam generator defines a thermal interface that maintains physical and radiological separation between the primary and secondary systems. Integrating the steam generator within the RPV can reduce external piping and welds, improve reliability, and enable a smaller, transportable power system consistent with the micro modular reactor configuration.

In certain embodiments, the steam generator can be a once-through steam generator in which at least one of the primary coolant or secondary coolant passes through the heat-exchange region in a single flow pass between an inlet and an outlet of the steam generator. In some embodiments, the primary coolant flows through the heat-exchange region of the steam generator in a once-through manner such that the primary coolant enters the steam generator, transfers heat across the heat-transfer surfaces, and exits the steam generator without recirculation within the heat-exchange region. For example, the steam generator can be a straight-tube heat-exchange assembly. In another example, the steam generator can be a helical-coil heat-exchange assembly disposed within the RPV. In this arrangement, the primary coolant can flow through helically wound tubes or coils extending between lower and upper manifolds, transferring heat to the secondary coolant as it flows upward through or around the coils. The once-through configuration and internal placement of the steam generator facilitate efficient heat transfer and stable primary-coolant circulation within the confined space of the RPV. This arrangement eliminates the external steam-generation equipment and extensive piping typical of full-scale pressurized-water reactor systems, contributing to the overall compact and integral design of the micro modular reactor.

In some embodiments, the steam generator can achieve high thermal and heat-transfer efficiency. The thermal efficiency of the primary-to-secondary heat transfer can be greater than 35 percent, 40 percent, or 45 percent. The heat-transfer efficiency of the steam generator can be greater than 75 percent, 80 percent, or 85 percent. The steam generation rate can exceed 85 kilograms per square meter per hour, 90 kilograms per square meter per hour, or 100 kilograms per square meter per hour. The nuclear power system can be designed to convert a substantial portion of the thermal energy produced within the reactor core into electrical energy through turbine-driven generation processes. The overall power-conversion efficiency of the system can depend on reactor scale, coolant parameters, and turbine configuration.

In the nuclear power system, steam produced within the steam generator can enter a secondary-coolant circuit that directs the steam to a turbine-generator assembly. The secondary-coolant circuit can be a secondary-coolant loop. After expansion through the turbine, the exhaust can flow to a condenser where it is cooled and condensed into liquid water. The condensed secondary coolant can be returned to the steam generator through feedwater lines or pumps, completing a closed recirculating secondary-coolant system.

The MMR can include a containment structure that surrounds the RPV. The containment structure can be configured to contain radioactive materials in the event of an abnormal operating condition. In some embodiments, the MMR can include a containment sleeve disposed around the RPV. The containment sleeve can define an annular enclosure that forms a containment boundary immediately surrounding the RPV. The sleeve can comprise a cylindrical central section with hemispherical or dished end caps positioned coaxially with the RPV. The cylindrical section can be spaced radially outward from the exterior surface of the RPV to create an interstitial volume that can accommodate coolant, inert gas, monitoring instrumentation, or passive safety-system interfaces. The containment sleeve can be fabricated from high-strength, corrosion-resistant steel or other reactor-grade materials suitable for high-pressure and high-temperature environments. The wall thickness of the containment sleeve can be selected relative to its diameter and design pressure to maintain structural integrity under all operating and transient conditions. In some embodiments, the sleeve can include internal stiffening rings or radial supports that maintain concentric alignment with the RPV and distribute loads evenly between the vessel and sleeve. The containment sleeve provides secondary pressure containment, mechanical protection, and localized radiation shielding around the RPV. The annular configuration can also promote uniform heat transfer to surrounding passive-cooling systems and can serve as a structural interface for the flooded suppression pool or other external containment features.

In certain embodiments, the RPV and containment sleeve can be submerged within a flooded suppression pool that functions as an integrated ultimate heat sink and radiation shield. The suppression pool can comprise a watertight vault surrounding at least a lower portion of the RPV. The pool can be dimensioned to absorb decay heat and attenuate gamma and neutron radiation, thereby limiting onsite and offsite radiation exposure during all modes of operation. Heat can be transferred from the RPV to the suppression pool through passive thermal pathways, including natural circulation and dedicated passive residual heat-removal circuits. These passive mechanisms can maintain core cooling without alternating-current power for at least 72 hours under design-basis decay heat conditions. The suppression pool can also provide physical protection against external hazards, reduce the need for extensive additional shielding around adjacent structures, and include interface connections for passive safety devices or emergency-cooling systems.

In addition to the containment sleeve, or in other embodiments in place of the containment sleeve, the containment structure can comprise a containment building formed of reinforced concrete and steel that surrounds the RPV and any associated containment sleeve. The containment building can provide an outer barrier that limits the release of radioactive material under abnormal operating conditions. The containment building can also protect the reactor system from external impacts or natural events such as seismic activity, flooding, or aircraft impact. In certain embodiments, the containment building can provide redundant barriers against the release of radioactive materials in combination with the containment sleeve or other containment structures. The nuclear power system can include multiple cooling subsystems for heat removal from the reactor and power-conversion components. The primary-coolant system removes heat from the reactor core, while a secondary-coolant system transfers heat to the turbine-generator assembly, as discussed above. A tertiary cooling system can remove residual heat from the condenser. The tertiary cooling system can include air-cooled or water-cooled heat-exchange equipment, such as cooling towers, heat-rejection basins, or natural water sources. The tertiary cooling system can discharge waste heat to the environment while maintaining a closed-loop flow of the secondary coolant and ensuring stable condenser operation.

In some embodiments, the nuclear power system can be designed for extended operational life through the selection of radiation-resistant and corrosion-resistant materials. The reactor pressure vessel, steam generator, and coolant piping can be formed from high-strength, low-alloy steels having resistance to embrittlement and mechanical degradation under neutron irradiation. Interior surfaces in contact with coolant can include corrosion-resistant coatings or liners composed of nickel-based alloys or other protective materials. Insulation materials surrounding the reactor vessel or associated piping can include ceramic fibers or comparable high-temperature materials selected to minimize heat loss and maintain structural stability. The combination of material strength, corrosion resistance, and thermal insulation can enable operational lifetimes exceeding several decades with reduced maintenance and inspection frequency.

In some embodiments, the nuclear power system can include an Instrumentation, Control, and Protection System (ICPS) configured to monitor, regulate, and protect reactor operations. The ICPS can include an automated control subsystem, a reactor protection subsystem, and supporting monitoring and communication elements that operate together to maintain safe and stable operation of the nuclear power system. The ICPS can comprise multiple subsystems, including reactor monitoring sensors, the automated control subsystem, controllers, and one or more user interfaces. These subsystems can operate cooperatively to maintain reactor performance within safe limits during all modes of operation. The ICPS can be located within the containment building, a local control room, or a remote supervisory facility, and can communicate with reactor components through redundant wired or wireless data links.

The reactor monitoring sensors can continuously measure parameters including coolant temperature, pressure, neutron flux, radiation levels, coolant flow rate, and power output. Sensors can be positioned throughout the reactor core and RPV of the MMR, and within the secondary-coolant circuit of the nuclear power system. Data collected from these sensors can be transmitted to the automated control subsystem for processing and evaluation. In some embodiments, the sensors can comprise radiation-hardened devices designed for continuous operation in high-temperature, high-radiation environments. The sensor suite can provide real-time data supporting automated control, operator monitoring, predictive maintenance, and diagnostic analysis.

The automated control subsystem can include one or more controllers configured to regulate MMR reactivity and primary-coolant parameters and to coordinate nuclear power system secondary-side operation. Each controller can receive sensor data, compare measured values to predefined thresholds or set points, and generate control signals to actuate control-rod drive mechanisms, primary-coolant pumps, pressurizer heaters, or spray assemblies. The automated control subsystem can include redundant processing channels and independent communication pathways to ensure continued operation in the event of a subsystem fault. In some embodiments, the controllers can implement model-based algorithms or predictive control logic to optimize reactivity control, coolant circulation, and load-following behavior. The automated control subsystem can execute shutdown sequences when off-normal conditions are detected, inserting control rods and transitioning the reactor to a safe subcritical state.

Each controller can be a digital computing device comprising one or more processors and a memory. The processors can include a microprocessor, microcontroller, programmable logic controller (PLC), application-specific integrated circuit (ASIC), or field-programmable gate array (FPGA). The memory can include non-transitory computer-readable media, such as flash memory, random-access memory (RAM), read-only memory (ROM), or other storage devices. The memory can store computer-readable instructions that, when executed by the processors, cause the controller to perform operations such as receiving and processing sensor inputs, comparing measured values to reference parameters, and generating control signals for actuators. The instructions can be implemented in software, firmware, or hardware logic and executed in one or more logical or virtual threads. The memory can also store operational data, calibration constants, and system models used by the controller to maintain reactor performance and safety.

In some embodiments, the controller can provide redundant processing channels and fault-tolerant logic to maintain control capability under single-failure conditions. The controller can operate as a standalone control unit or as part of a distributed control network that includes local and supervisory controllers. Portions of the controller hardware can be located within the containment structure, within a local control room, or at a remote monitoring station.

The user interfaces can provide operators with visual and manual control access to reactor systems. The user interfaces can include control consoles, graphical displays, touchscreen interfaces, and alarm annunciation panels that present real-time information on reactor status and system performance. Through the user interfaces, operators can monitor temperature, pressure, neutron flux, and coolant flow, adjust operating parameters, and initiate or override automated control actions. In certain embodiments, the user interfaces can be integrated into a remote monitoring station, enabling remote operation or supervision of the nuclear power system to minimize on-site staffing requirements.

The ICPS can further include a reactor protection subsystem configured to monitor critical parameters and initiate automatic shutdowns under predefined safety conditions. The protection subsystem can operate independently of non-safety control functions and can directly actuate control-rod drives and isolation valves as required. The protection logic can be powered by dedicated battery systems or emergency power supplies to ensure functionality during a loss of offsite power. The integration of automated control, monitoring sensors, and safety logic provides continuous, autonomous operation of the MMR while maintaining compliance with reactor safety and protection design criteria.

In certain embodiments, the MMR can include an emergency core cooling system (ECCS) that provides coolant to the reactor core in the event of a loss of normal coolant flow. The ECCS can prevent overheating by delivering coolant through dedicated injection lines or gravity-fed reservoirs. In some embodiments, the MMR can also include the ICPS that monitors reactor parameters such as temperature, pressure, coolant level, neutron flux, and power output. These systems can automatically adjust control-rod position or activate shutdown mechanisms to maintain safe reactor operation.

In some embodiments, the nuclear power system can include spent-fuel handling and waste-management subsystems. After use, fuel elements can be transferred from the reactor vessel to a spent-fuel pool located within a shielded area. The spent-fuel pool can contain water that provides both cooling and radiation shielding for the spent fuel. The fuel elements can remain in the pool for a predetermined cooling period before being transferred to dry-cask storage or to a reprocessing facility. The waste-management subsystems can include equipment for collection, processing, and containment of low-level and high-level radioactive waste generated during operation or maintenance. Radiation shielding can be incorporated around the reactor vessel, steam generator, and containment structure to reduce external radiation exposure. The spent-fuel handling and waste-management subsystems can be located within or adjacent to a containment or service building depending on plant configuration.

In some embodiments, the nuclear power system can include backup battery or auxiliary power systems. The nuclear power system can also include a control room or remote monitoring station equipped with sensors and digital interfaces to monitor reactor performance and safety systems. The control room can provide real-time data and automatic shutdown capability. In some embodiments, the control and monitoring systems can be designed to support remote or unattended operation, reducing on-site staffing requirements.

In some embodiments, the nuclear power system can include passive safety systems that operate without external power or active mechanical intervention. A passive residual heat removal system can remove decay heat from the reactor core using gravity-driven coolant flow and natural convection. A passive containment cooling system can dissipate heat from the RPV and containment structure using air circulation or gravity-fed water reservoirs. In some embodiments, the MMR can also include passive hydrogen recombiners located within the containment structure to mitigate hydrogen buildup during abnormal events.

In certain embodiments, the nuclear power system can include the ICPS or subsystems thereof for continuous monitoring of reactor parameters and automated operation. The subsystem can process input from temperature, pressure, neutron-flux, and coolant-flow sensors and can adjust control elements accordingly. Automated shutdown mechanisms can initiate rapid insertion of control rods in response to predefined conditions. The ICPS can improve reliability, reduce human error, and enhance situational awareness for both local and remote operators. Portions of the digital control hardware can be located within the MMR and portions within balance-of-plant facilities.

The materials used in the MMR components, including the RPV, steam generator, and coolant systems, can be selected for high strength, corrosion resistance, and radiation tolerance to achieve long operational lifetimes. In some embodiments, the MMR can achieve high fuel burnup and extended refueling intervals compared to conventional reactors, improving operational efficiency and reducing waste volume. The MMR can employ factory-based modular construction techniques that enable rapid on-site assembly, enhanced quality control, and lower construction costs.

In certain embodiments, the MMR can be designed to withstand environmental and external events, including seismic activity, flooding, and extreme weather. Structural reinforcements, base isolation systems, and elevated positioning of safety equipment can provide additional resilience. The design can also incorporate simplified maintenance requirements and reduced mechanical complexity by using passive and naturally driven systems where appropriate.

In some embodiments, a nuclear power system can include auxiliary and other balance-of-plant subsystems in addition to the reactor and coolant assemblies described above. The auxiliary subsystems can include chemical-treatment systems that maintain coolant purity and regulate chemistry within the primary and secondary circuits. The auxiliary subsystems can also include fire-protection systems having detection and suppression equipment positioned to protect reactor and plant components. Ventilation and heating, ventilation, and air-conditioning (HVAC) systems can provide controlled environmental conditions within enclosures that house the reactor vessel, secondary-side equipment, or control areas. The HVAC systems can include filtration or containment assemblies for managing airborne particulates or radioactive materials. Monitoring and service systems can support inspection, refueling, or replacement of components. The auxiliary and balance-of-plant subsystems can be located within or adjacent to a containment building depending on installation configuration.

In some embodiments, the nuclear power system can include emergency and backup power subsystems. The emergency and backup power subsystems can provide electrical power to critical components during loss of external power. The subsystems can include battery assemblies, uninterruptible power supplies, or diesel-driven generators positioned to supply power to cooling pumps, control systems, and safety instrumentation. The subsystems can further include automatic transfer equipment that initiates power delivery upon detection of grid interruption. The emergency and backup power subsystems can be arranged within protected enclosures or within portions of a containment or service building.

The nuclear power system can be designed with simplified mechanical architecture to reduce maintenance and inspection requirements. The system can include a reduced number of active mechanical components, such as pumps, valves, and piping, relative to conventional reactor designs. The simplified system architecture can reduce potential failure points and facilitate modular replacement of assemblies. The arrangement of components within compact, accessible enclosures can enable efficient inspection, servicing, or replacement of equipment during planned maintenance intervals.

In some embodiments, the nuclear power system can be designed for installation and operation under a wide range of environmental conditions. The system can include structural reinforcements and base-isolation assemblies that provide seismic resistance for the reactor vessel, containment structures, and associated support equipment. The system can further include protective enclosures and elevated platforms that position safety-critical components, such as emergency-cooling and power-supply equipment, above potential flood levels. The structures enclosing the reactor and balance-of-plant equipment can be designed to withstand extreme weather events, including high-wind or impact loads. The system can be manufactured using modular construction techniques in which major assemblies, such as the reactor vessel, steam generator, and piping modules, are fabricated at a manufacturing facility and transported to the installation site for assembly. The modular fabrication and transportable configuration can reduce on-site construction activities and enable deployment in remote or constrained environments.

The nuclear power system integrates the MMR with secondary-side power-conversion equipment, passive safety features, digital controls, and modular construction to achieve compactness, safety, and efficient operation. The integration of the reactor, steam generator, and pressurizer within a single pressure vessel distinguishes the MMR from conventional large-scale pressurized-water reactors and enables deployment in locations and applications not suited to traditional nuclear plants. Multiple nuclear power systems can be operated in a coordinated modular configuration for staged capacity addition, load-following, or redundancy, with each system operating independently and contributing to a common electrical bus or process-heat header. In certain embodiments, selected containment or support features can be shared among co-located MMR modules while maintaining independent safety boundaries for each module. Electrical output from the turbine-generator assemblies can be transmitted to external power networks through transformer and switchyard equipment associated with the nuclear power system.

Features and advantages of the nuclear power systems and MMRs disclosed herein will be apparent from the descriptions of exemplary embodiments herein, as illustrated in the accompanying drawings. Like reference numerals are used to designate identical, functionally similar, or structurally similar elements throughout the several views. The embodiments described herein are provided for purposes of illustration and explanation, and are not intended to limit the scope of the disclosure. Variations, alternatives, and modifications to the described nuclear power systems and MMRs structures and configurations can be implemented by a person skilled in the art based on the teachings presented herein.

The following discussion references the accompanying drawings, which illustrate representative implementations of the systems and components described above. These drawings present exemplary configurations of the micro modular reactor (MMR) and the nuclear power system and reference features discussed in greater detail in the foregoing description. The figures are illustrative and are not drawn to scale. The embodiments shown can be combined or adapted in other permutations, configurations, and arrangements consistent with the disclosure herein. Additionally, unless context dictates otherwise, any of the features discussed above can be used in the system and components described herein.

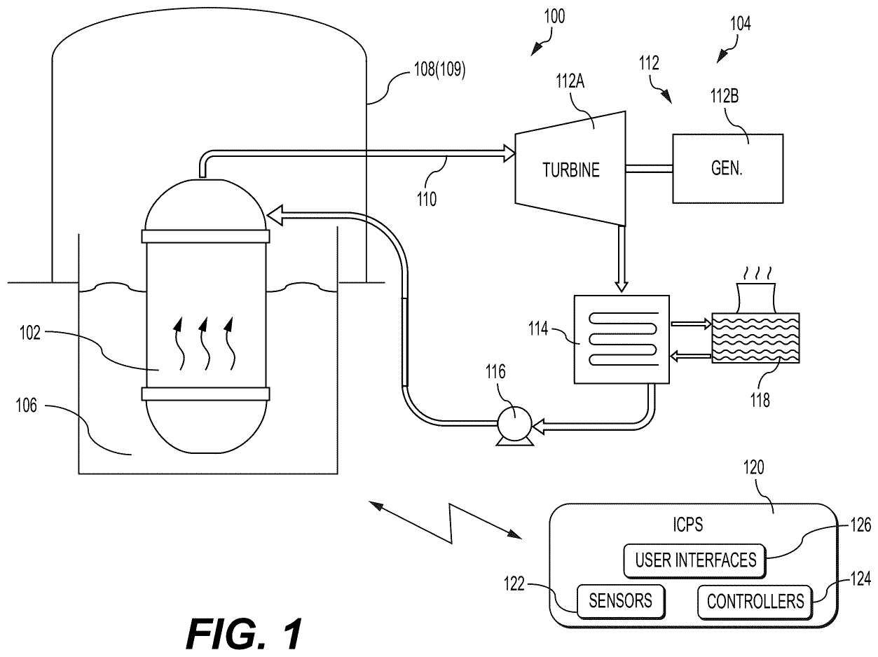

FIG. 1 is a schematic of a nuclear power system 100 according to embodiments discussed herein. The nuclear power system 100 includes an MMR 102 as described above. As noted, the MMR 102 generates thermal energy that can be used for various processes, such as electrical power generation or industrial heat applications. The nuclear power system 100 further includes a power-conversion region 104 thermally coupled to the MMR 102 and configured to receive heat from the MMR 102 for conversion to power such as electrical energy.

As shown in FIG. 1, heat generated within the MMR 102 is transferred to a secondary-coolant loop 110 that circulates a secondary coolant between the MMR 102 and a turbine-generator assembly 112. The turbine-generator assembly 112 includes a turbine 112a and a generator 112b. Steam in the secondary-coolant loop 110 expands through the turbine 112a, driving the generator 112b to produce electrical power. Exhaust from the turbine 112a is directed to a condenser 114, where the secondary coolant is condensed to liquid form. The condenser 114 can be thermally coupled to a tertiary cooling system 118 that removes residual heat from the secondary coolant and rejects it to the environment through a cooling tower or natural heat sink. A feedwater pump 116 returns the condensed secondary coolant to the MMR 102, completing the closed circuit of the secondary-coolant loop 110.

In the embodiment of FIG. 1, the MMR 102 can be positioned within a flooded suppression pool 106 in which a reactor pressure vessel of the MMR 102 is at least partially submerged. The suppression pool 106 can provide an integrated ultimate heat sink and radiation shield, as well as a secondary physical barrier around the MMR 102 as discussed above. An above-grade reactor building 108 can enclose a reactor bay, provide environmental protection, and support maintenance functions such as fuel handling and component replacement. In some embodiments, the reactor building 108 can be constructed as or can include a containment structure 109 that provides additional confinement for radioactive materials. The reactor building 108 can further include overhead crane access and service platforms configured to allow removal and installation of reactor modules while maintaining radiation shielding and containment integrity. Although depicted as external to the reactor building 108, the power-conversion region 104 can alternatively be located within the reactor building 108 or within a separate adjacent structure.

The nuclear power system 100 further includes an Instrumentation, Control, and Protection System (ICPS) 120, schematically represented in FIG. 1. The ICPS 120 can monitor and control operation of the MMR 102 and the power-conversion region 104. As discussed above, the ICPS 120 can include one or more sensors 122 positioned to measure parameters such as coolant temperature, pressure, flow rate, neutron flux, and power output within the MMR 102, the power-conversion region 104, such as the secondary-coolant loop 110, and other associated systems like the tertiary cooling system 118. Signals from the sensors can be transmitted to one or more controllers 124 configured to process the data and to regulate system components, including control-rod drive mechanisms, pumps, and turbine-load controls, to maintain stable operating conditions. The ICPS 120 can also incorporate protection logic that automatically initiates shutdown procedures when monitored parameters exceed predetermined limits. User interfaces 126 can provide real-time display of reactor and system parameters and allow manual input or override of automated functions. The ICPS 120 and its associated user interfaces 126 can be implemented using distributed components, with certain portions located on site within the reactor building 108 and other portions located remotely at a supervisory control or monitoring facility, enabling both local and remote operation and oversight of the nuclear power system 100.

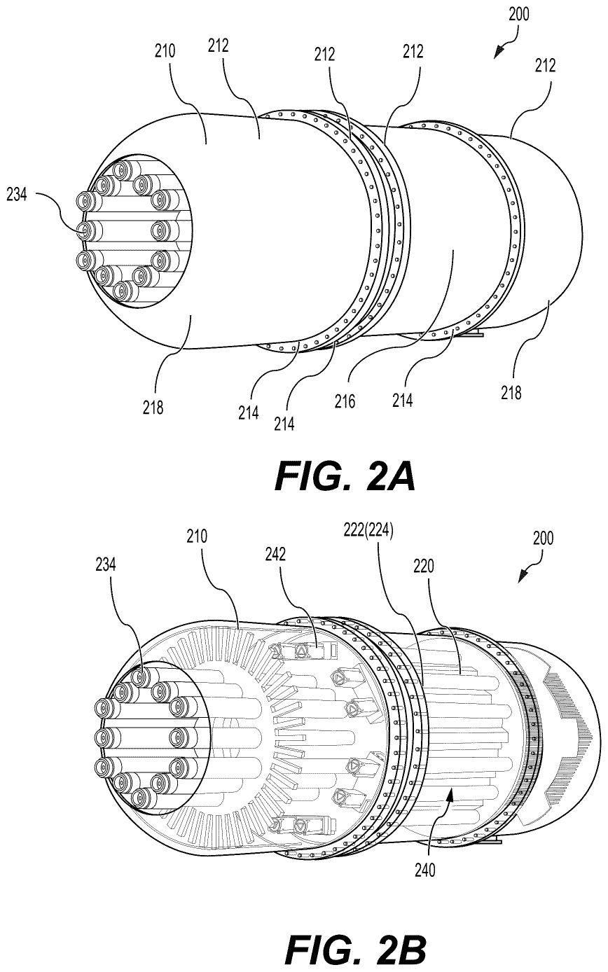

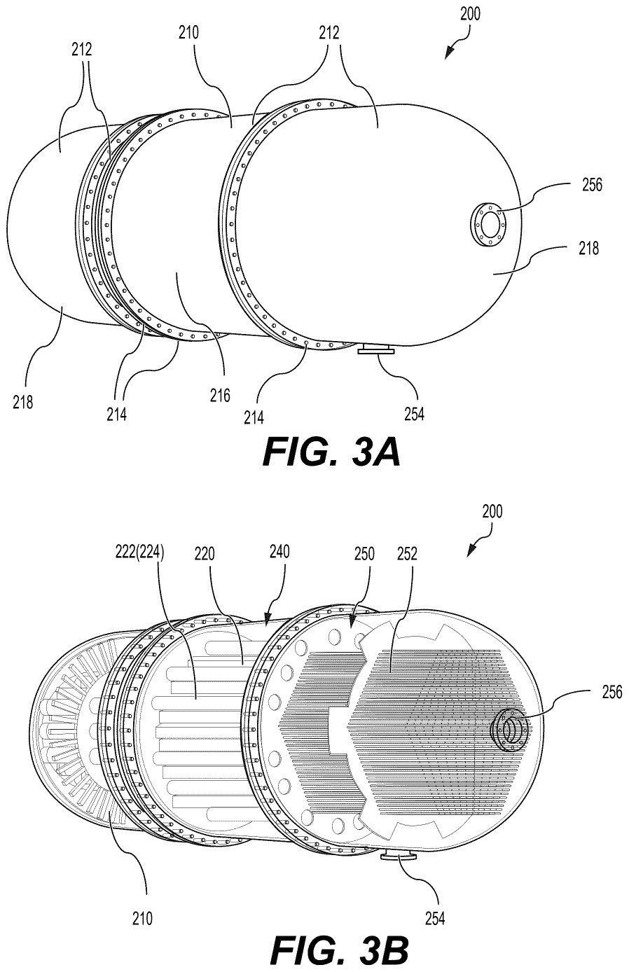

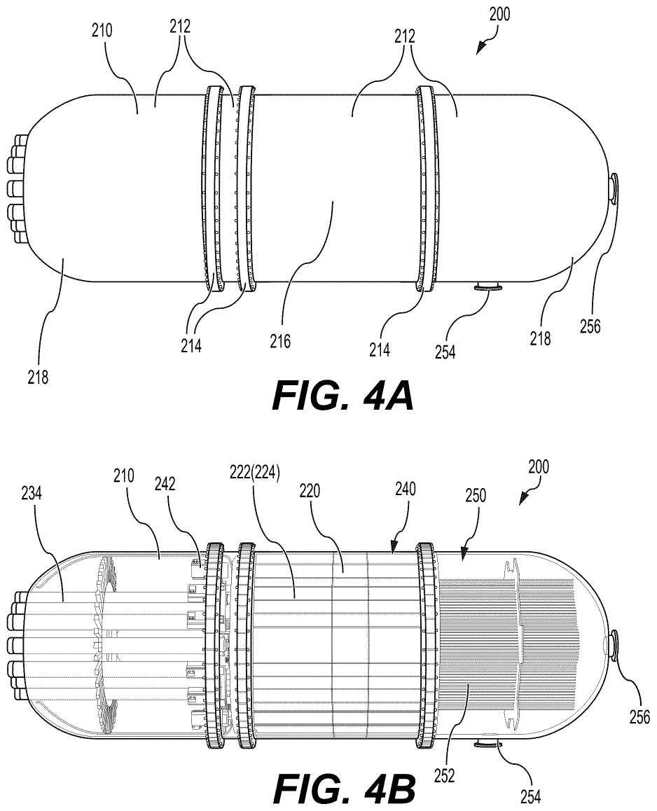

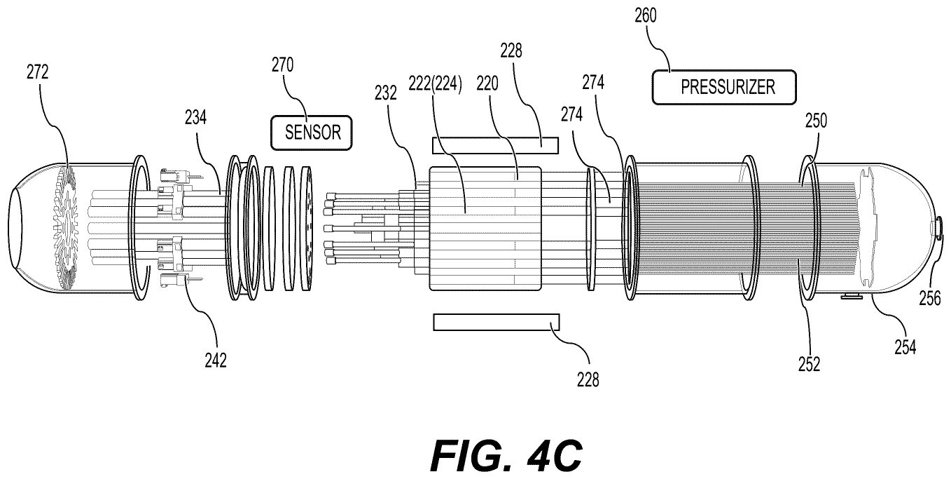

FIGS. 2A to 4C show one MMR 200 that can be used as the MMR 102 in the nuclear power system 100 shown in FIG. 1. FIGS. 2A and 2B are perspective views showing one end of the MMR 200, and FIGS. 3A and 3B are perspective views showing the other end of the MMR 200. FIGS. 4A, 4B, and 4C are side views of the MMR 200. FIGS. 2B, 3B, 4B, and 4C show a reactor pressure vessel 210 of the MMR 200 as transparent so the internal components can be seen. FIG. 4C is an exploded view of the MMR 200.

The MMR 200 illustrated in FIGS. 2A to 4C is an integral, modular reactor design in which the primary systems are contained within a single RPV 210. The reactor pressure vessel 210 shown here can include a plurality of vessel segments 212 that can be connected to each other through suitable pressure tight connections, such as circumferential flanges 214. The RPV 210 can have the shape described above, with a central cylindrical section 216 and hemispherical ends 218.

The reactor core 220 is positioned within the one of the vessel segments 212 of the RPV 210. The reactor core 220 includes a plurality of fuel assemblies 222 arranged in a compact lattice to define the active core region. Each fuel assembly 222 can include multiple fuel elements 224 containing enriched uranium fuel as described above. The fuel assemblies 222 are supported and aligned within the vessel by internal core support structures and are surrounded by one or more neutron reflectors 228 that improve neutron economy within the compact geometry of the MMR 200. Reactivity within the reactor core 220 can be controlled through a set of control rods 232 that are insertable into the core. The control rods 232 are operated by corresponding control-rod drive mechanisms 234. The drive mechanisms 234 can move the control rods 232 to adjust reactor power during operation and can rapidly insert the rods under to achieve a shutdown condition.

A primary-coolant circuit 240 circulates within the RPV 210 to transfer thermal energy generated in the reactor core 220 to an integral steam generator 250. The primary coolant, which can be light water as discussed above, flows through the core primary-coolant flow passages. Heat is extracted from the heated primary-coolant and transferred across a network of heat-transfer structures 252 to the secondary-coolant loop 110 (FIG. 1) of the nuclear power system 100 (FIG. 1). The secondary coolant can enter the steam generator 250 through a secondary coolant inlet 254 and exit as heated steam through a secondary coolant outlet 256, thereby completing the heat exchange between the primary and secondary systems. The cooled primary coolant then returns to one end of the reactor core 220, such as through passages positioned around the periphery of the reactor core 220, to complete the internal flow path. One or more primary-coolant pumps 242 can be disposed within the RPV 210 to circulate the primary coolant through this closed circuit during normal operation. A pressurizer 260 can be located within the RPV 210.

The pressurizer 260 can define a pressure-control volume within the RPV 210 and primary-coolant circuit 240 to maintain the pressure of the primary coolant, such as in a liquid phase under operating temperature and pressure conditions, in the manner discussed above. The integral placement of the pressurizer 260 within the RPV 210 eliminates external pressure-control vessels and associated piping, contributing to the compact, transportable, and self-contained nature of the MMR 200.

Additional features can be incorporated within the RPV 210 to support reactor monitoring, safety, and maintenance functions. These can include in-vessel instrumentation sensors 270 positioned to measure coolant temperature, pressure, flow rate, and neutron flux, as well as structural supports 272, and primary system piping 274. These elements are arranged to maintain the integral configuration of the MMR 200, in which the primary systems, pressure-control equipment, and heat-transfer components are contained within the single reactor pressure vessel.

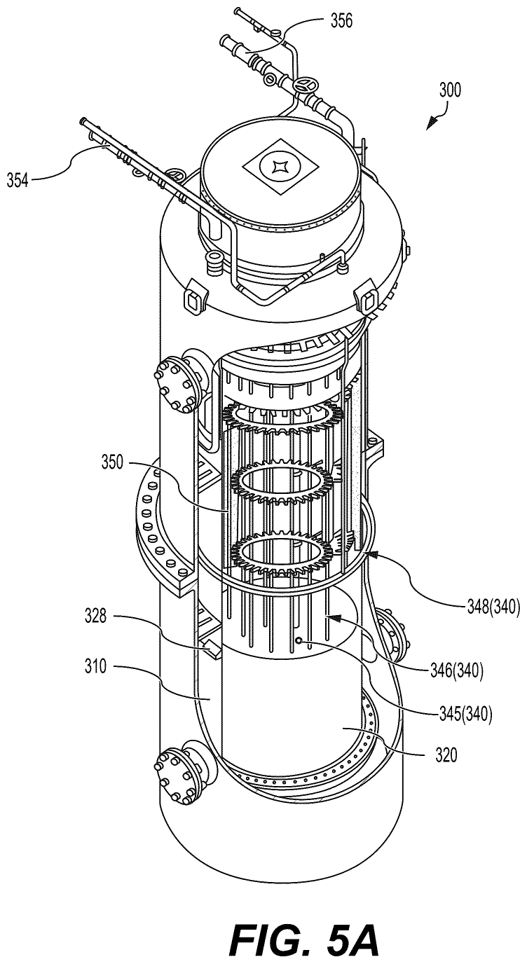

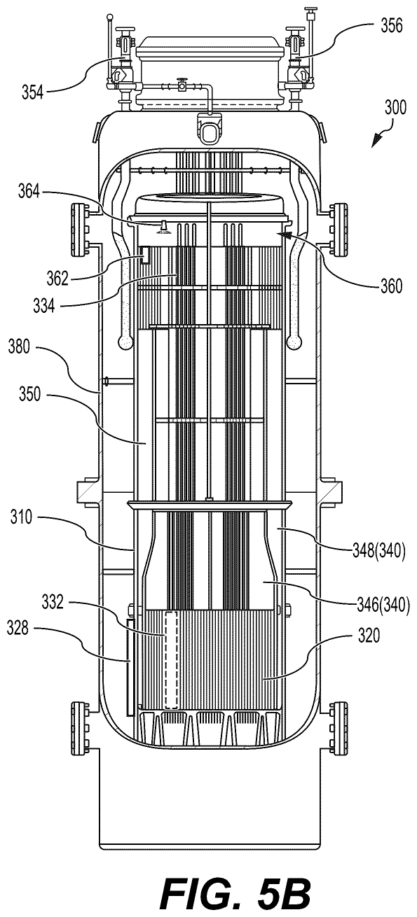

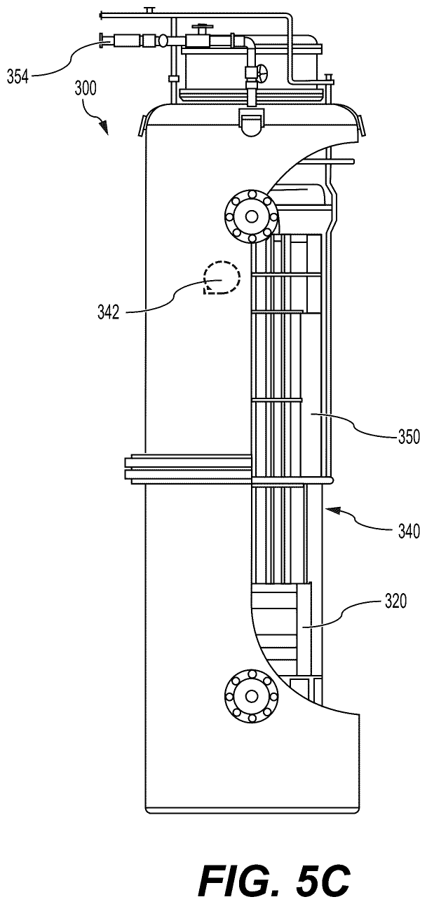

FIGS. 5A to 5C show another MMR 300 that can be used as the MMR 102 in the nuclear power system 100 shown in FIG. 1. The MMR 300 shown in FIGS. 5A to 5C is similar to the MMR 200 discussed above with reference to FIGS. 2A to 4C. In FIGS. 5A to 5C, 300-series reference numerals are used for the various components, and the 300-series reference numerals identify features that are the same as or similar to the features identified by 200-series reference numerals in the previous embodiment. Accordingly, the detailed description of such components may be omitted, and the details of the systems and components discussed above can also apply to the MMR 300. In a similar way, features and components of the MMR 300 discussed below can also apply to the MMR 200. FIG. 5A is a perspective partial cutaway view of the MMR 300, FIG. 5B is a front partial cutaway view of the MMR 300, and FIG. 5C is a side partial cutaway view of the MMR 300.

The MMR 300 includes the major systems and components described above within a reactor pressure vessel (RPV) 310. The RPV 310 can house the reactor core 320, the steam generator 350, the pressurizer 360, and the primary-coolant circuit 340. The primary-coolant circuit 340 in this MMR 300 is a primary-coolant loop including one or more primary-coolant pumps 342, riser passages 344, and downcomer passages 346 that establish vertical coolant flow between the lower and upper regions of the vessel. During operation, thermal energy generated within the reactor core 320 is transferred to the primary coolant as it passes through the fuel assemblies and core flow passages 345, increasing the coolant temperature and reducing its density. The heated coolant rises through the riser passages 344 toward the upper portion of the RPV 310, where it transfers heat to the steam generator 350. The cooled primary coolant then flows downward through the downcomer passages 346 around the periphery of the core region, completing the circulation path. The primary-coolant pumps 342 can circulate the primary coolant through the primary-coolant circuit 340. Alternatively, in some embodiments, the primary-coolant pumps 342 can be omitted, and the MMR 300 can operate in a natural-circulation configuration in which primary coolant motion is driven by density differences between the heated coolant rising from the reactor core 320 and the cooled coolant descending from the steam generator 350.

The pressurizer 360 can be located within an upper region of the RPV 310. The pressurizer 360 can define a pressure-control volume within the primary-coolant circuit 340. The pressurizer 360 can maintain the primary coolant at a pressure that prevents boiling during normal operation. The pressurizer 360 can include one or more pressurizer heaters 362 positioned in the pressurizer 360. The pressurizer heaters 362 can increase the temperature of the coolant in the pressurizer 360 to raise the system pressure when needed. The pressurizer 360 can also include one or more pressurizer spray assemblies 364 located in an upper portion of the pressurizer 360. The pressurizer spray assemblies 364 can introduce cooler primary coolant into the vapor region of the pressurizer 360 to condense a portion of the vapor and reduce system pressure. The pressurizer 360, the pressurizer heaters 362, and the pressurizer spray assemblies 364 are located entirely within the RPV 310. The integral placement of these components eliminates external pressure-control vessels and associated piping.

The RPV 310 is surrounded by a containment structure 380. The containment structure 380 is spaced radially outward from the exterior surface of the RPV 310 to define an annular gap therebetween. The containment structure 380 can be constructed from metal, as discussed above. The containment structure 380 can serve as a secondary pressure boundary. The containment structure 380 can also provide localized radiation shielding. The annular gap between the RPV 310 and the containment structure 380 can permit passive heat transfer from the RPV 310 to external cooling systems. The arrangement shown maintains the integral, modular configuration characteristic of the micro modular reactor designs described herein, in which the primary components are enclosed within a single, transportable reactor vessel assembly.

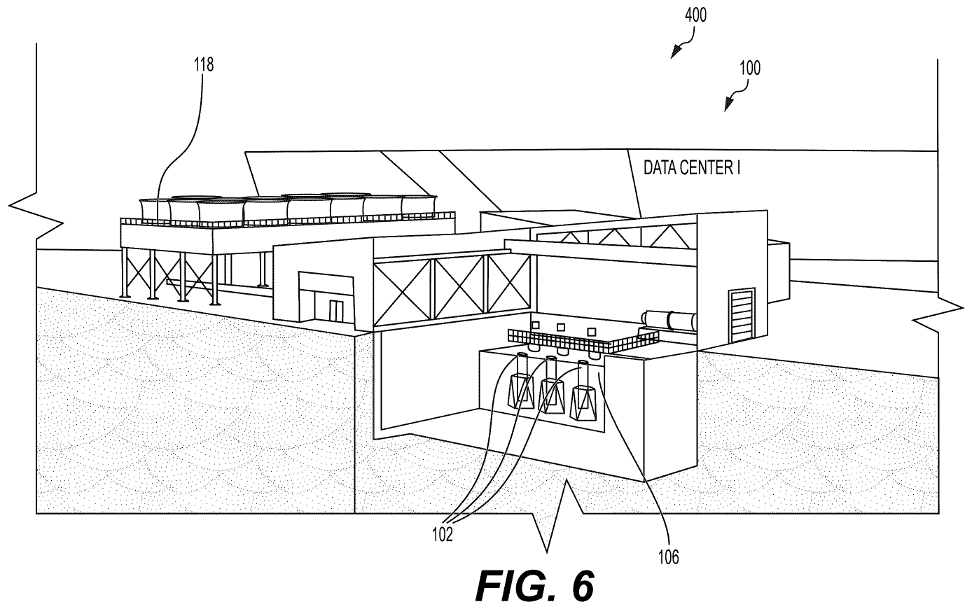

FIG. 6 is a schematic depicting multi-unit configuration 400 of the nuclear power system 100 to increase aggregate electrical output and to provide operational redundancy. The modular multi-unit configuration 400 can include a plurality of MMRs 102 located within a common suppression pool 106. Each MMR 102 can include an individual reactor pressure vessel at least partially submerged in the water of the suppression pool 106 and coupled to associated secondary side components, such as a corresponding secondary-coolant loop 110 (FIG. 1). Each MMR 102 can include a separate secondary-coolant system (e.g., the secondary-coolant loop 110) and a corresponding turbine-generator assembly 112 (FIG. 1). The generators 112b (FIG. 1) can be connected individually or collectively to one or more electrical buses to deliver combined electrical output or to provide independent power channels. The arrangement can allow individual MMRs 102 to be added, removed, or serviced without interrupting operation of the other units, providing scalability and continuous power generation within the modular multi-unit configuration 400.

The nuclear power systems described herein, such as nuclear power system 100 and the multi-unit configuration 400 shown in FIG. 6, can be deployed in a variety of environments. The systems can be installed at remote, off-grid, or temporary sites where conventional large-scale power infrastructure is unavailable. The systems can be used to supply electrical and thermal power to industrial facilities, research stations, or defense installations. The systems can also be integrated into data-center, desalination, or district-heating operations. Each reactor module can operate as a stand-alone power source or as part of a coordinated array of multiple modules. Multiple modules can be interconnected to increase total electrical output or to provide redundancy during maintenance or variable load conditions. The modular construction of the systems can facilitate transportation, assembly, and removal using standard over-the-road or marine equipment.

Further aspects of the present disclosure are provided by the subject matter of the following clauses.

A micro integral nuclear reactor including a reactor core, a steam generator, primary coolant circuit, and a reactor pressure vessel. The reactor core includes a plurality of fuel assemblies. Each fuel assembly comprises a plurality of fuel elements. The plurality of fuel assemblies define core primary coolant flow passages through the reactor core. The reactor core is structured such that, when operating, a primary coolant flows through the core primary coolant flow passages and absorbs heat generated by nuclear fission within the reactor core. Each fuel element containing uranium-235 (U-235), and the fuel of the reactor core is enriched to a concentration of 5 percent or greater and less than 20 percent U-235 by weight of uranium within the reactor core. The steam generator is fluidly connected to the core primary coolant flow passages to receive the primary coolant and, when operating, transfer heat from the primary coolant to a secondary coolant to generate steam. The primary coolant circuit fluidly couples the core primary coolant flow passages and the steam generator such that, when operating, the primary coolant circulates between the reactor core and the steam generator. The reactor pressure vessel houses the reactor core, the steam generator, and the primary coolant circuit. When operating, the micro integral nuclear reactor produces a thermal power output from 6 megawatts-thermal (MWt) to 60 MWt.

A nuclear power system including a micro integral nuclear reactor, a turbine-generator assembly, a condenser, and a secondary-coolant circuit. The micro integral nuclear reactor includes a reactor core, a steam generator, primary coolant circuit, and a reactor pressure vessel. The reactor core includes a plurality of fuel assemblies. Each fuel assembly comprises a plurality of fuel elements. The plurality of fuel assemblies define core primary coolant flow passages through the reactor core. The reactor core is structured such that, when operating, a primary coolant flows through the core primary coolant flow passages and absorbs heat generated by nuclear fission within the reactor core. Each fuel element containing uranium-235 (U-235), and the fuel of the reactor core is enriched to a concentration of 5 percent or greater and less than 20 percent U-235 by weight of uranium within the reactor core. The steam generator is fluidly connected to the core primary coolant flow passages to receive the primary coolant and, when operating, transfer heat from the primary coolant to a secondary coolant to generate steam. The primary coolant circuit fluidly couples the core primary coolant flow passages and the steam generator such that, when operating, the primary coolant circulates between the reactor core and the steam generator. The reactor pressure vessel houses the reactor core, the steam generator, and the primary coolant circuit. The turbine-generator assembly is fluidly coupled to the steam generator to receive the steam and, when operating, generate electrical power and discharge exhaust. The condenser is fluidly coupled to the turbine-generator assembly to condense the exhaust into condensed secondary coolant. The secondary-coolant circuit is fluidly coupling the steam generator, the turbine-generator assembly, and the condenser such that, when operating, the condensed secondary coolant is returned from the condenser to the steam generator to complete a recirculating flow path. When operating, the nuclear power system produces an electrical power output from 2 megawatts-electric (MWe) to 20 MWe.

A micro integral nuclear reactor including a reactor core, one or more neutron reflectors surrounding the reactor core, a steam generator, primary coolant loop, a pressurizer, and a reactor pressure vessel. The reactor core includes a plurality of fuel assemblies. Each fuel assembly comprises a plurality of fuel elements. The plurality of fuel assemblies define core primary coolant flow passages through the reactor core. The reactor core is structured such that, when operating, a primary coolant flows through the core primary coolant flow passages and absorbs heat generated by nuclear fission within the reactor core. Each fuel element containing uranium-235 (U-235), and the fuel of the reactor core is enriched to a concentration of 5 percent or greater and less than 20 percent U-235 by weight of uranium within the reactor core. The steam generator is fluidly connected to the core primary coolant flow passages to receive the primary coolant and, when operating, transfer heat from the primary coolant to a secondary coolant to generate steam. The one or more neutron reflectors are circumferentially disposed around the reactor core. The steam generator is fluidly connected to the core primary coolant flow passages to receive the primary coolant and, when operating, transfer heat from the primary coolant to a secondary coolant to generate steam. The primary coolant loop fluidly couples the core primary coolant flow passages and the steam generator such that, when operating, the primary coolant circulates between the reactor core and the steam generator. The primary coolant is light water. The pressurizer is fluidly connected to the primary coolant loop and configured to regulate the pressure of the primary coolant at an operating pressure sufficient to maintain the primary coolant in a liquid state during operation. The reactor pressure vessel houses the reactor core, the steam generator, the primary coolant loop, and the pressurizer. When operating, the micro integral nuclear reactor produces a thermal power output from 6 megawatts-thermal (MWt) to 60 MWt.

The micro integral nuclear reactor of any preceding clause, wherein the fuel of the reactor core is enriched to a concentration of 5 percent to 10 percent or less U-235 by weight of uranium within the reactor core.

The micro integral nuclear reactor of any preceding clause, wherein the primary coolant is light water.

The micro integral nuclear reactor of any preceding clause, further comprising a pressurizer located within the reactor pressure vessel and fluidly connected to the primary coolant circuit and configured to regulate the pressure of the primary coolant at an operating pressure sufficient to maintain the primary coolant in a liquid state during operation.

The micro integral nuclear reactor of any preceding clause, wherein the steam generator is a once-through steam generator in which the primary coolant flows during operation through the steam generator in a single pass between an inlet and an outlet of the steam generator.

The micro integral nuclear reactor of any preceding clause, wherein the steam generator includes a straight-tube heat-exchange assembly through which the primary coolant flows during operation.

The micro integral nuclear reactor of any preceding clause, further comprising one or more neutron reflectors surrounding the reactor core, the one or more neutron reflectors being circumferentially disposed around the reactor core.

The micro integral nuclear reactor of any preceding clause, wherein the primary coolant circuit is a primary coolant loop with a portion of the primary coolant loop circumferentially disposed around the reactor core.

The micro integral nuclear reactor of any preceding clause, wherein the reactor pressure vessel comprises a cylindrical central section and hemispherical end caps at opposing axial ends of the cylindrical central section.

The micro integral nuclear reactor of any preceding clause, wherein the cylindrical central section of the reactor pressure vessel includes one or more circumferential flanges or coupling bands joining a plurality of vessel segments to form the reactor pressure vessel.

The micro integral nuclear reactor of any preceding clause, wherein a height of the reactor pressure vessel is greater than a diameter of the reactor pressure vessel.

The micro integral nuclear reactor of any preceding clause, wherein a diameter of the reactor pressure vessel is from 1 m to 5 m.

The micro integral nuclear reactor of any preceding clause, wherein a diameter of the reactor pressure vessel is from 1 m to 3 m.

The micro integral nuclear reactor of any preceding clause, wherein the primary coolant circuit is a primary coolant loop and the micro integral nuclear reactor further comprises a primary-coolant pump disposed within the reactor pressure vessel and coupled to the primary-coolant loop to circulate the primary coolant through the core primary coolant flow passages and the steam generator during operation.

Although this invention has been described with respect to certain specific exemplary embodiments, various modifications, adaptations, and alternatives will be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention is determined by any claims supportable by this disclosure and the equivalents of the embodiments and structures discussed herein, rather than by the foregoing description.

1. A micro integral nuclear reactor comprising:
a reactor core including a plurality of fuel assemblies, each fuel assembly comprising a plurality of fuel elements, the plurality of fuel assemblies defining core primary coolant flow passages through the reactor core, the reactor core being structured such that, when operating, a primary coolant flows through the core primary coolant flow passages and absorbs heat generated by nuclear fission within the reactor core, each fuel element containing uranium-235 (U-235), and the fuel of the reactor core being enriched to a concentration of 5 percent or greater and less than 20 percent U-235 by weight of uranium within the reactor core;
a steam generator fluidly connected to the core primary coolant flow passages to receive the primary coolant and, when operating, transfer heat from the primary coolant to a secondary coolant to generate steam;
a primary coolant circuit fluidly coupling the core primary coolant flow passages and the steam generator such that, when operating, the primary coolant circulates between the reactor core and the steam generator; and
a reactor pressure vessel housing the reactor core, the steam generator, and the primary coolant circuit;
wherein, when operating, the micro integral nuclear reactor produces a thermal power output from 6 megawatts-thermal (MWt) to 60 MWt.

2. The micro integral nuclear reactor of claim 1, wherein the fuel of the reactor core is enriched to a concentration of 5 percent to 10 percent or less U-235 by weight of uranium within the reactor core.

3. The micro integral nuclear reactor of claim 1, wherein the primary coolant is light water.

4. The micro integral nuclear reactor of claim 1, further comprising a pressurizer located within the reactor pressure vessel and fluidly connected to the primary coolant circuit and configured to regulate the pressure of the primary coolant at an operating pressure sufficient to maintain the primary coolant in a liquid state during operation.

5. The micro integral nuclear reactor of claim 1, wherein the steam generator is a once-through steam generator in which the primary coolant flows during operation through the steam generator in a single pass between an inlet and an outlet of the steam generator.

6. The micro integral nuclear reactor of claim 5, wherein the steam generator includes a straight-tube heat-exchange assembly through which the primary coolant flows during operation.

7. The micro integral nuclear reactor of claim 1, further comprising one or more neutron reflectors surrounding the reactor core, the one or more neutron reflectors being circumferentially disposed around the reactor core.

8. The micro integral nuclear reactor of claim 7, wherein the primary coolant circuit is a primary coolant loop with a portion of the primary coolant loop circumferentially disposed around the reactor core.

9. The micro integral nuclear reactor of claim 1, wherein the reactor pressure vessel comprises a cylindrical central section and hemispherical end caps at opposing axial ends of the cylindrical central section.

10. The micro integral nuclear reactor of claim 9, wherein the cylindrical central section of the reactor pressure vessel includes one or more circumferential flanges or coupling bands joining a plurality of vessel segments to form the reactor pressure vessel.

11. The micro integral nuclear reactor of claim 1, wherein a height of the reactor pressure vessel is greater than a diameter of the reactor pressure vessel.

12. The micro integral nuclear reactor of claim 1, wherein a diameter of the reactor pressure vessel is from 1 m to 5 m.

13. The micro integral nuclear reactor of claim 1, wherein a diameter of the reactor pressure vessel is from 1 m to 3 m.

14. The micro integral nuclear reactor of claim 1, wherein the primary coolant circuit is a primary coolant loop and the micro integral nuclear reactor further comprises a primary-coolant pump disposed within the reactor pressure vessel and coupled to the primary-coolant loop to circulate the primary coolant through the core primary coolant flow passages and the steam generator during operation.

15. A nuclear power system comprising:
a micro integral nuclear reactor including:
a reactor core including a plurality of fuel assemblies, each fuel assembly comprising a plurality of fuel elements, the plurality of fuel assemblies defining core primary coolant flow passages through the reactor core, the reactor core being structured such that, when operating, a primary coolant flows through the core primary coolant flow passages and absorbs heat generated by nuclear fission within the reactor core, each fuel element containing uranium-235 (U-235), and the fuel of the reactor core being enriched to a concentration of 5 percent or greater and less than 20 percent U-235 by weight of uranium within the reactor core;
a steam generator fluidly connected to the core primary coolant flow passages to receive the primary coolant and, when operating, transfer heat from the primary coolant to a secondary coolant to generate steam;
a primary coolant circuit fluidly coupling the core primary coolant flow passages and the steam generator such that, when operating, the primary coolant circulates between the reactor core and the steam generator; and
a reactor pressure vessel housing the reactor core, the steam generator, and the primary coolant circuit;
a turbine-generator assembly fluidly coupled to the steam generator to receive the steam and, when operating, generate electrical power and discharge exhaust;
a condenser fluidly coupled to the turbine-generator assembly to condense the exhaust into condensed secondary coolant; and
a secondary-coolant circuit fluidly coupling the steam generator, the turbine-generator assembly, and the condenser such that, when operating, the condensed secondary coolant is returned from the condenser to the steam generator to complete a recirculating flow path,
wherein, when operating, the nuclear power system produces an electrical power output from 2 megawatts-electric (MWe) to 20 MWe.

16. A micro integral nuclear reactor comprising:
a reactor core including a plurality of fuel assemblies, each fuel assembly comprising a plurality of fuel elements, the plurality of fuel assemblies defining core primary coolant flow passages through the reactor core, the reactor core being structured such that, when operating, a primary coolant flows through the core primary coolant flow passages and absorbs heat generated by nuclear fission within the reactor core, each fuel element containing uranium-235 (U-235), and the fuel of the reactor core being enriched to a concentration of 5 percent or greater and less than 20 percent U-235 by weight of uranium within the reactor core;
one or more neutron reflectors surrounding the reactor core, the one or more neutron reflectors being circumferentially disposed around the reactor core;
a steam generator fluidly connected to the core primary coolant flow passages to receive the primary coolant and, when operating, transfer heat from the primary coolant to a secondary coolant to generate steam;
a primary coolant loop fluidly coupling the core primary coolant flow passages and the steam generator such that, when operating, the primary coolant circulates between the reactor core and the steam generator, wherein the primary coolant is light water;
a pressurizer fluidly connected to the primary coolant loop and configured to regulate the pressure of the primary coolant at an operating pressure sufficient to maintain the primary coolant in a liquid state during operation; and
a reactor pressure vessel housing the reactor core, the steam generator, the primary coolant loop, and the pressurizer,
wherein, when operating, the micro integral nuclear reactor produces a thermal power output from 6 megawatts-thermal (MWt) to 60 MWt.

17. A nuclear power system comprising:
the micro integral nuclear reactor of claim 16;
a turbine-generator assembly fluidly coupled to the steam generator to receive the steam and, when operating, generate electrical power and discharge exhaust;
a condenser fluidly coupled to the turbine-generator assembly to condense the exhaust into condensed secondary coolant; and
a secondary-coolant circuit fluidly coupling the steam generator, the turbine-generator assembly, and the condenser such that, when operating, the condensed secondary coolant is returned from the condenser to the steam generator to complete a recirculating flow path,
wherein, when operating, the micro power system produces an electrical power output from 2 megawatts-electric (MWe) to 20 MWe.

18. The micro integral nuclear reactor of claim 16, wherein a diameter of the reactor pressure vessel is from 1 m to 5 m.

19. The micro integral nuclear reactor of claim 16, wherein the reactor pressure vessel comprises a cylindrical central section and hemispherical end caps at opposing axial ends of the cylindrical central section.

20. The micro integral nuclear reactor of claim 19, wherein the cylindrical central section of the reactor pressure vessel includes one or more circumferential flanges or coupling bands joining a plurality of vessel segments to form the reactor pressure vessel.
